(19) United States
(12) Patent Application Publication
(10) Pub. No.: US 2025/0105976 A1
(43) Pub. Date: Mar. 27, 2025

(54) METHODS AND DEVICES FOR REQUESTING RELEASE OF CONFIGURATION OF PERIODIC SOUNDING REFERENCE SIGNAL

(71) Applicant: ZTE Corporation, Shenzhen (CN)

(72) Inventors: Feng XIE, Shenzhen (CN); Hanchao Liu, Shenzhen (CN); Fei Wang, Shenzhen (CN)

(73) Assignee: ZTE Corporation, Shenzhen (CN)

(21) Appl. No.: 18/971,317

(22) Filed: Dec. 6, 2024

Related U.S. Application Data
(63) Continuation of application No. PCT/CN2022/122899, filed on Sep. 29, 2022.

(51) Int. Cl. H04L 5/00; H04W 72/21; H04W 72/231

(52) U.S. Cl. CPC H04L 5/0051; H04W 72/21; H04W 72/231

(57) ABSTRACT

The present disclosure describes methods, system, and devices for requesting release of configuration of periodic sounding reference signal. The method includes transmitting, by a wireless communication device to a wireless communication node, first information for requesting to release a periodic SRS configuration; receiving, by the wireless communication device from the wireless communication node, second information for releasing the periodic SRS configuration; and releasing, by the wireless communication device, the periodic SRS configuration.

### TECHNICAL FIELD

The present disclosure is directed generally to wireless communications. Particularly, the present disclosure relates to methods and devices for requesting release of configuration of periodic sounding reference signal.

### BACKGROUND

Wireless communication technologies are moving the world toward an increasingly connected and networked society. In the present disclosure, various embodiments are described for requesting release of configuration of periodic sounding reference signal.

In 4G and 5G mobile communication systems, sounding reference signal (SRS), as an uplink reference signal, plays a vital role in the process of air interface physical transmission. The SRS is transmitted by a user equipment (UE) to a network node, and is mainly used for obtaining the uplink channel state information and the downlink channel state information. It plays an important role in uplink channel state estimation, uplink precoding, downlink channel state estimation, downlink precoding and beam management. The SRS includes several types, for example, periodic SRS, semi-persistent SRS, and aperiodic SRS.

There are issues/problems associated with existing SRS schemes. For example, when periodic SRS is configured, the UE transmits SRS periodically. However, when the UE does not need to periodically transmit SRS, for example, when uplink and downlink channel state estimation is not required, transmitting SRS periodically may waste battery power of the UE, especially when the UE's available battery power is low/insufficient. This problem/issue may reduce the endurance of the UE.

The present disclosure describes various embodiments for requesting release of configuration of periodic sounding reference signal, which may address at least one of issues/problems associated with the existing system to improve the performance of the wireless communication.

### SUMMARY

This document relates to methods, systems, and devices for wireless communication, and more specifically, for requesting release of configuration of periodic sounding reference signal. The various embodiments in the present disclosure may be beneficial to improve wireless communication technology, to increase the resource utilization efficiency, and/or to boost performance of the wireless communication.

In one embodiment, the present disclosure describes a method for wireless communication. The method includes transmitting, by a wireless communication device to a wireless communication node, first information for requesting to release a periodic SRS configuration; receiving, by the wireless communication device from the wireless communication node, second information for releasing the periodic SRS configuration; and releasing, by the wireless communication device, the periodic SRS configuration.

In another embodiment, the present disclosure describes another method for wireless communication. The method includes transmitting, by a wireless communication device to a wireless communication node, first information for requesting to configure a periodic SRS configuration; receiving, by the wireless communication device from the wireless communication node, second information for configuring the periodic SRS configuration; and configuring, by the wireless communication device, the periodic SRS configuration.

In another embodiment, the present disclosure describes another method for wireless communication. The method includes receiving, by a wireless communication node from a wireless communication device, first information for requesting to release a periodic SRS configuration; and transmitting, by the wireless communication node to the wireless communication device, second information for releasing the periodic SRS configuration.

In another embodiment, the present disclosure describes another method for wireless communication. The method includes receiving, by a wireless communication node from a wireless communication device, first information for requesting to configure a periodic SRS configuration; and transmitting, by the wireless communication node to the wireless communication device, second information for configuring the periodic SRS configuration.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4 shows a flow diagram of an exemplary embodiment for wireless communication.

FIG. 5A shows a flow diagram of a method for wireless communication.

FIG. 5B shows a flow diagram of another method for wireless communication.

FIG. 6A shows a flow diagram of another method for wireless communication.

FIG. 6B shows a flow diagram of another method for wireless communication.

FIG. 7 shows a flow diagram of another exemplary embodiment for wireless communication.

FIG. 8 shows a flow diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for requesting release of configuration of periodic sounding reference signal. In various embodiments, requesting release of configuration of periodic sounding reference signal may be triggered by a user equipment (UE), rather than by a radio access network (RAN, for example, a base station).

Next generation (NG), or 5th generation (5G), wireless communication may provide a range of capabilities from downloading with fast speeds to support real-time low-latency communication. New generation (NG) mobile communication system are moving the world toward an increasingly connected and networked society. High-speed and low-latency wireless communications rely on efficient network resource management and allocation between user equipment and wireless access network nodes (including but not limited to wireless base stations).

In 4G and 5G mobile communication systems, sounding reference signal (SRS), as an uplink reference signal, plays a vital role in the process of air interface physical transmission. The SRS is transmitted by a user equipment (UE) to a network node, and is mainly used for obtaining the uplink channel state information and the downlink channel state information. It plays an important role in uplink channel state estimation, uplink precoding, downlink channel state estimation, downlink precoding and beam management.

In some implementations, for example, 5G NR mobile communication system, the time domain behavior of SRS resources may include periodic, semi-persistent, and aperiodic. The SRS may occupy 1, or 2, or 4 consecutive symbols from the last six symbols of a slot. The SRS may have a comb structure, that is, it is transmitted on every 2 or 4 subcarriers. The SRS may support up to 4 antenna ports, and the starting antenna port number may be 1000.

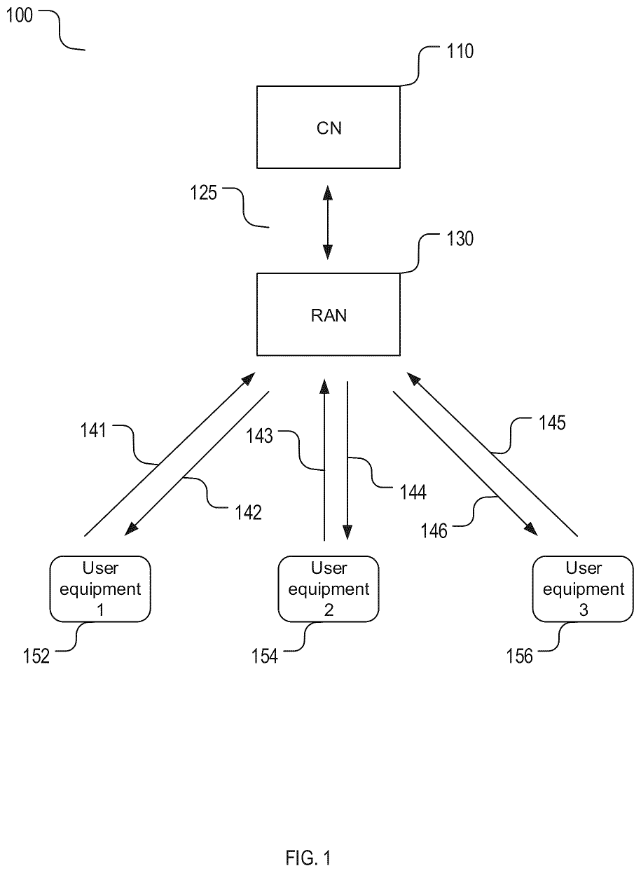

FIG. 1 shows a wireless communication system 100 including a core network (CN) 110, a radio access network (RAN) 130, and one or more user equipment (UE) (152, 154, and 156). The RAN 130 may include a wireless network base station, or a NG radio access network (NG-RAN) base station or node, which may include a nodeB (NB, e.g., a gNB) in a mobile telecommunications context. In one implementation, the core network 110 may include a 5G core network (5GC), and the interface 125 may include a new generation (NG) interface.

Referring to FIG. 1, a first UE 152 may wirelessly receive one or more downlink communication 142 from the RAN 130 and wirelessly send one or more uplink communication 141 to the RAN 130. Likewise, a second UE 154 may wirelessly receive downlink communication 144 from the RAN 130 and wirelessly send uplink communication 143 to the RAN 130; and a third UE 156 may wirelessly receive downlink communication 146 from the RAN 130 and wirelessly send uplink communication 145 to the RAN 130. For example but not limited to, a downlink communication may include a physical downlink shared channel (PDSCH) or a physical downlink control channel (PDCCH), and a uplink communication may include a physical uplink shared channel (PUSCH) or a physical uplink control channel (PUCCH).

In some implementations, a UE may be configured with one or more SRS resource sets, and each resource set may include one or more SRS resources. SRS resource sets may be used for different purposes. For example, uplink channel state estimation and uplink precoding, downlink channel state estimation and downlink precoding (based on uplink and downlink channel reciprocity), beam management, etc. Wherein, the uplink and downlink channel reciprocity refers to that the uplink signal and downlink signal are transmitted on the same frequency, and it can be considered that the uplink air interface channel and the downlink air interface channel are approximately the same. Therefore, the uplink reference signal can be used to estimate the downlink channel state, and conversely, the downlink reference signal can be used to estimate the uplink channel state.

In some implementations, a periodic SRS may be used for channel state estimation, so that the wireless network node may receive the channel state information (CSI) of each UE. A UE configured with periodic SRS resources, may transmit SRS periodically. Even when the channel state information does not need to be updated, transmitting SRS will not stop, which will waste the available power of the UE and affect the battery life of the UE.

The present disclosure describes various embodiments for requesting release of configuration of periodic sounding reference signal, wherein the requesting release may be transmitted by a UE. For a non-limiting example, a UE may transmit an indication information to the wireless network node to request releasing the periodic SRS configuration for the UE, so that the UE may stop transmitting SRS periodically.

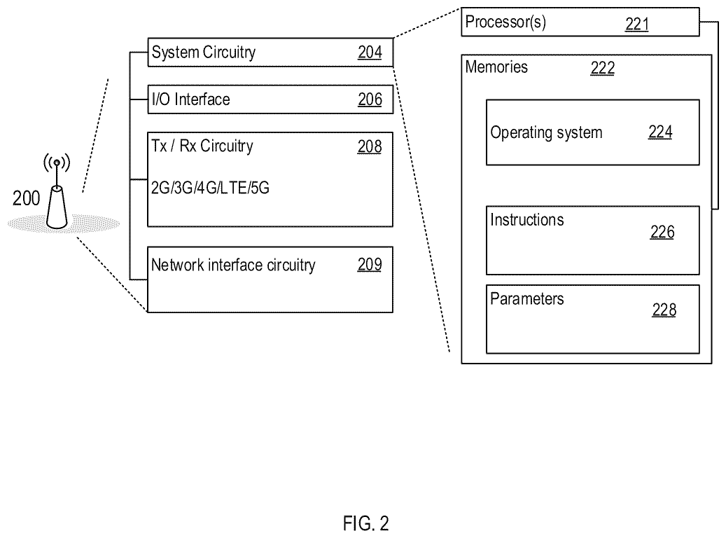

FIG. 2 shows an exemplary a radio access network or a wireless communication base station 200. The base station 200 may include radio transmitting/receiving (Tx/Rx) circuitry 208 to transmit/receive communication with one or more UEs, and/or one or more other base stations. The base station may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

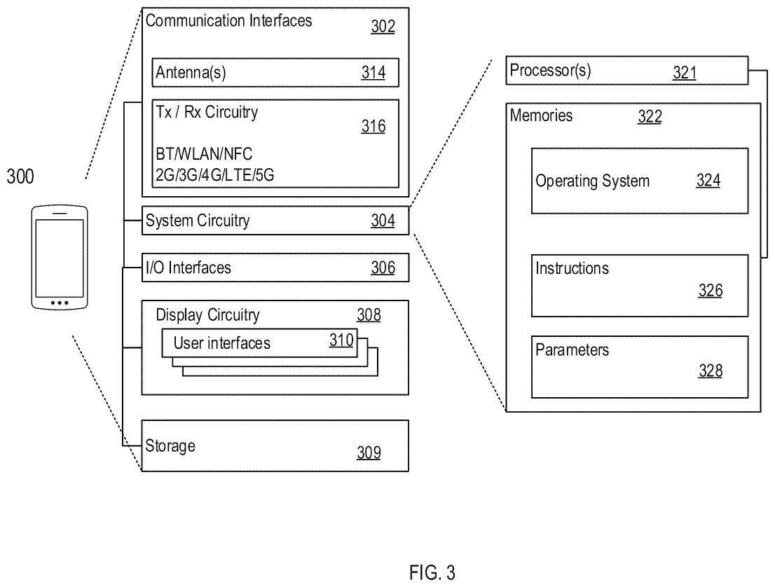

FIG. 3 shows an exemplary user equipment (UE) 300. The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several embodiments of methods and devices for requesting release of configuration of periodic sounding reference signal, which may be triggered by a user equipment (UE), so that the UE may stop transmitting SRS periodically. Furthermore, in various embodiments, a UE may transmit an indication information to the wireless network node to request to configure periodic SRS configuration for the UE, so that the UE may start transmitting SRS periodically. Any embodiment describes in the present disclosure may be implemented, partly or totally, on the wireless network base station and/or the user equipment described above in FIGS. 2 and 3.

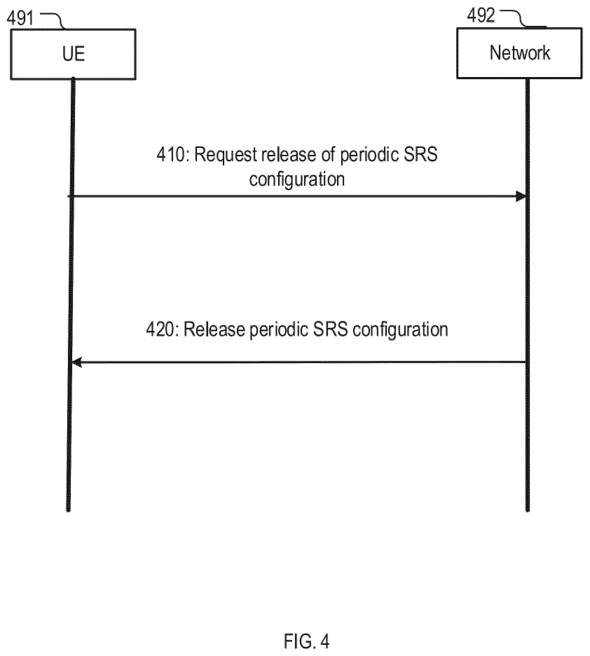

FIG. 4 shows a relevant process in various embodiments. In step 410, a UE (491) may transmit a first information to request release of periodic SRS configuration to a network (492). In step 420, the network may transmit a second information indicating a release of the periodic SRS configuration.

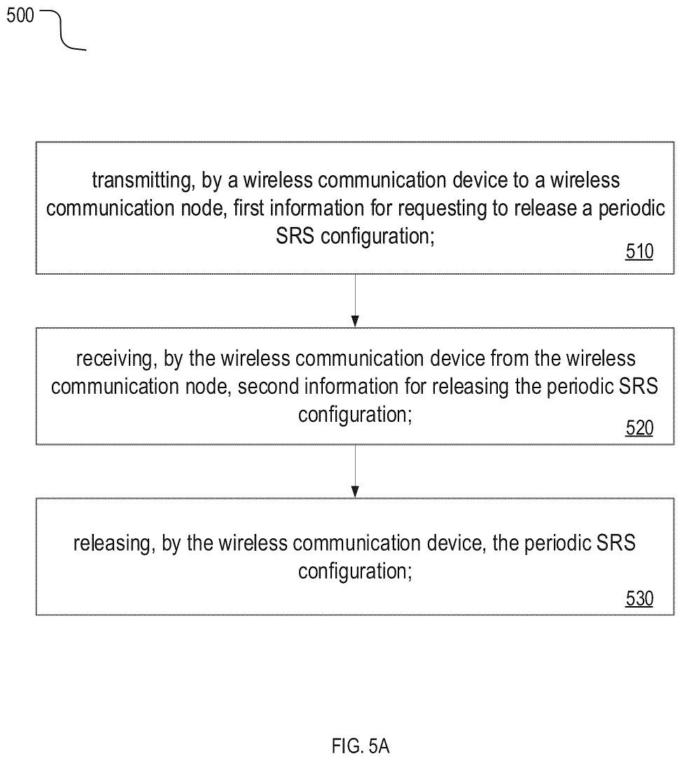

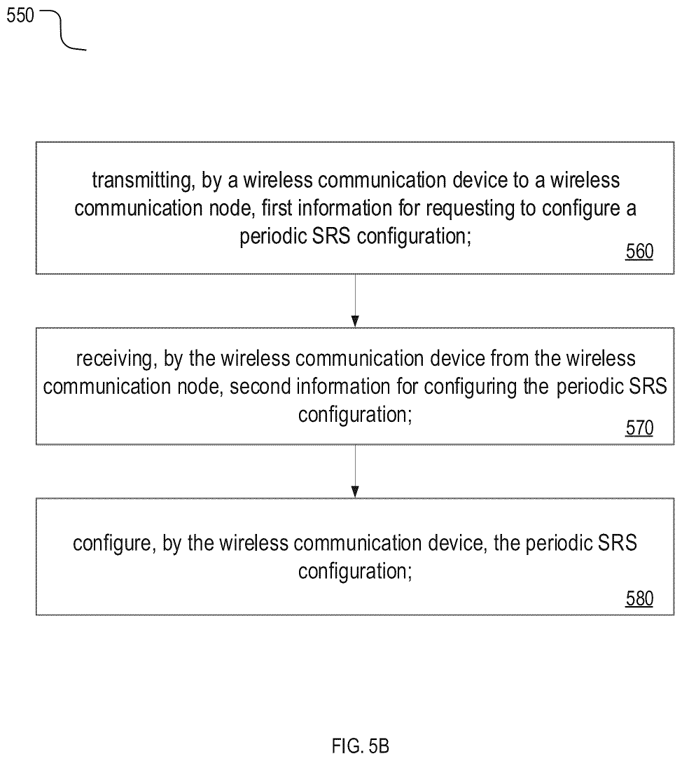

In various embodiments, FIG. 5A shows a flow diagram of a method 500 for wireless communication. The method 500 may include a portion or all of the following steps: step 510, transmitting, by a wireless communication device to a wireless communication node, first information for requesting to release a periodic SRS configuration; step 520, receiving, by the wireless communication device from the wireless communication node, second information for releasing the periodic SRS configuration; and/or step 530, releasing, by the wireless communication device, the periodic SRS configuration.

In various embodiments, FIG. 5B shows a flow diagram of a method 550 for wireless communication. The method 550 may include a portion or all of the following steps: step 560, transmitting, by a wireless communication device to a wireless communication node, first information for requesting to configure a periodic SRS configuration; step 570, receiving, by the wireless communication device from the wireless communication node, second information for configuring the periodic SRS configuration; and/or step 580, configure, by the wireless communication device, the periodic SRS configuration.

In some implementations, the wireless communication device may include a UE; and/or the wireless communication node may include a network, a base station, or a RAN.

In some implementations, the first information may be an uplink control information (UCI) having a fixed size of one bit, wherein a value of the UCI being one indicates requesting to release the periodic SRS configuration.

In some implementations, the first information may be a medium access control control element (MAC CE) comprising a MAC header with a logical channel index (LCID) and having a fixed size of zero bit, wherein the MAC CE with the LCID indicates requesting to release the periodic SRS configuration.

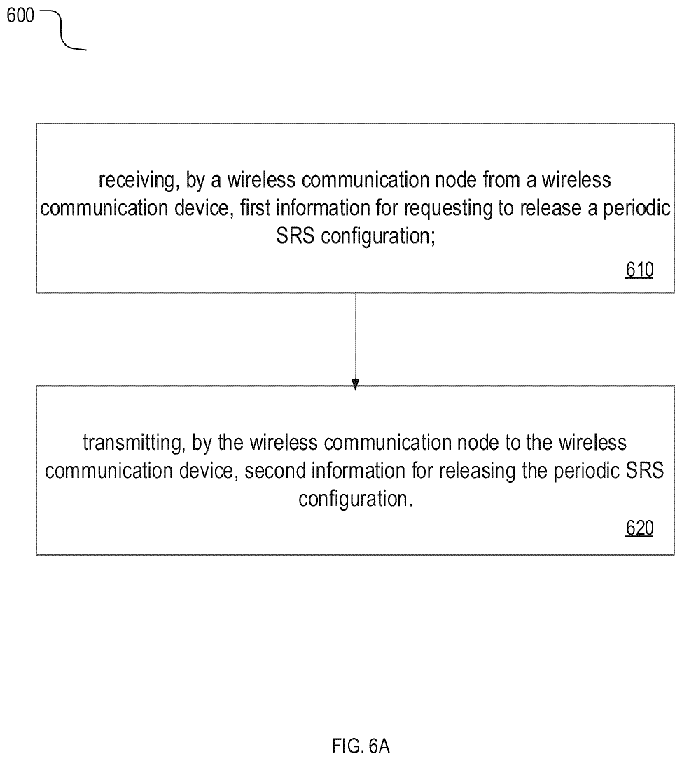

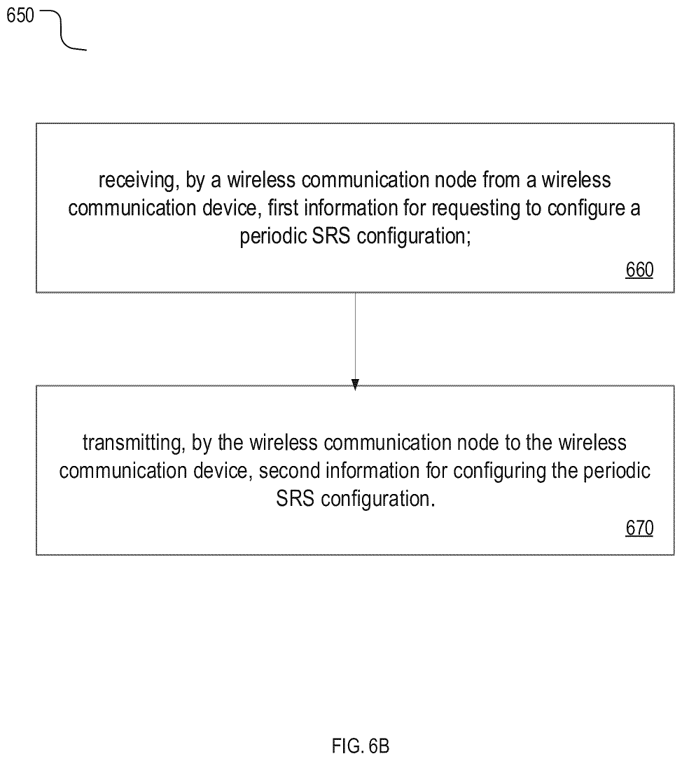

In various embodiments, FIG. 6A shows a flow diagram of a method 600 for wireless communication. The method 600 may include a portion or all of the following steps: step 610, receiving, by a wireless communication node from a wireless communication device, first information for requesting to release a periodic SRS configuration; and/or step 620, transmitting, by the wireless communication node to the wireless communication device, second information for releasing the periodic SRS configuration.

In various embodiments, FIG. 6B shows a flow diagram of a method 650 for wireless communication. The method 650 may include a portion or all of the following steps: step 660, receiving, by a wireless communication node from a wireless communication device, first information for requesting to configure a periodic SRS configuration; and/or step 670, transmitting, by the wireless communication node to the wireless communication device, second information for configuring the periodic SRS configuration.

In some implementations, the wireless communication device may include a UE; and/or the wireless communication node may include a network, a base station, or a RAN.

In some implementations, the first information may be an uplink control information (UCI) having a fixed size of one bit, wherein a value of the UCI being one indicates requesting to release the periodic SRS configuration.

In some implementations, the first information may be a medium access control control element (MAC CE) comprising a MAC header with a logical channel index (LCID) and having a fixed size of zero bit, wherein the MAC CE with the LCID indicates requesting to release the periodic SRS configuration.

For one non-limiting example, when a UE is configured with periodic SRS configuration but SRS is not required to be transmitted, the UE may transmit an indication information to the wireless network node to request releasing the periodic SRS configuration for the UE, and stop transmitting SRS periodically.

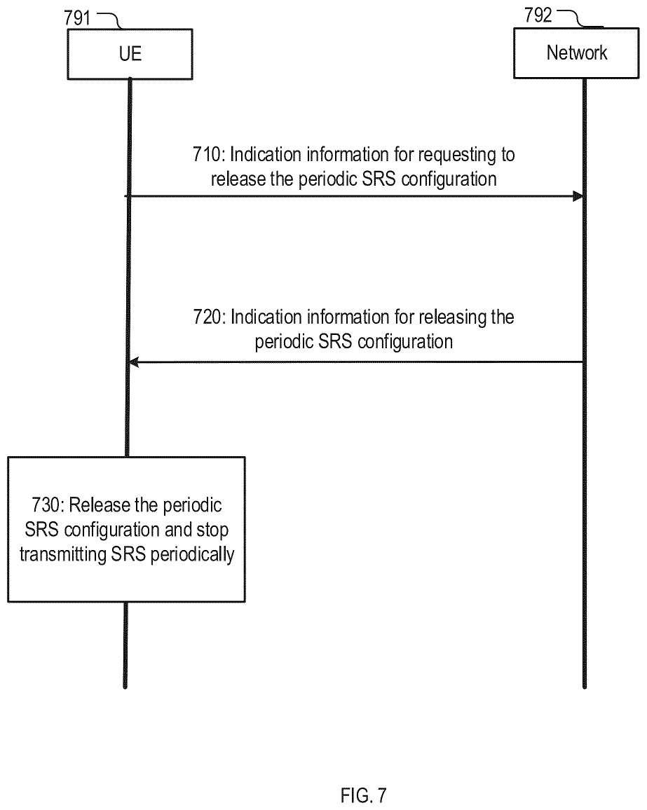

FIG. 7 shows a system flow of a UE (791) requesting a wireless network node (e.g., a network) (792) to release the periodic SRS configuration. In step 710: the UE transmits an indication information to the wireless network node to request releasing periodic SRS configuration. In step 720: the wireless network node transmits indication information for releasing periodic SRS configuration to the UE. In step 730, the UE releases the periodic SRS configuration and stops transmitting SRS periodically.

In some implementations, from the UE side, the UE flow of requesting to release periodic SRS configuration may include a portion or all of the following: the UE transmits an indication information to the wireless network node to request releasing periodic SRS configuration; the UE receives an indication information for releasing the periodic SRS configuration from the wireless network node; and/or the UE releases the periodic SRS configuration and stops transmitting SRS periodically.

For another non-limiting example, when a UE is configured with periodic SRS configuration, and uplink or downlink channel state estimation is not required or uplink or downlink channel state estimation is not required frequently, the UE may transmit an indication information to a wireless network node to request releasing the periodic SRS configuration for the UE, so as to stop the periodic transmission of SRS. Alternatively in other situation, for example, when the available power of the UE is insufficient, in order to increase the battery life, the UE may request to release the periodic SRS configuration and obtain the uplink channel state information by using other methods.

In some implementations, other methods to obtain the uplink or downlink channel state information may include but not limited to: using semi-persistent SRS resources or aperiodic SRS resources. In some implementations, for a time division duplexing (TDD) system, the UE may obtain the uplink channel state information (CSI) by receiving the downlink channel state information reference signal (CSI-RS) based on the uplink and downlink channel reciprocity.

In some implementations, after stop transmitting SRS, UE may use CSI-RS to obtain uplink channel state information based on channel reciprocity.

In some implementations, from a UE side, a UE flow of requesting release of periodic SRS configuration may include a portion or all of the following: the UE transmits an indication information to the wireless network node to request releasing periodic SRS configuration; the UE receives an indication information for releasing the periodic SRS configuration from the wireless network node; and/or the UE releases the periodic SRS configuration and stops transmitting SRS periodically.

For another non-limiting example, in situation of communication sensing integration, a mobile crowd sensing (MCS) scheme includes a new sensing paradigm that uses embedded sensors in mobile UE devices to collect environment related information. The MCS system may mainly include a sensing UE device and a sensing platform, in which the sensing platform is mainly responsible for the release and management of sensing tasks. The sensing platform may be deployed on an edge server, and the edge server may be deployed near the radio access network (RAN) node. In the MCS, the UE periodically reports channel state information to the wireless network node. The UE applies periodic SRS resources to enable the network node to obtain channel state information. When the available power of the UE is insufficient, UE may exit the sensing task and actively request releasing periodic SRS resources to avoid affecting other UE. The wireless network node deletes the UE information from the UE list for the sensing task and releases the SRS resource instance configured for the UE.

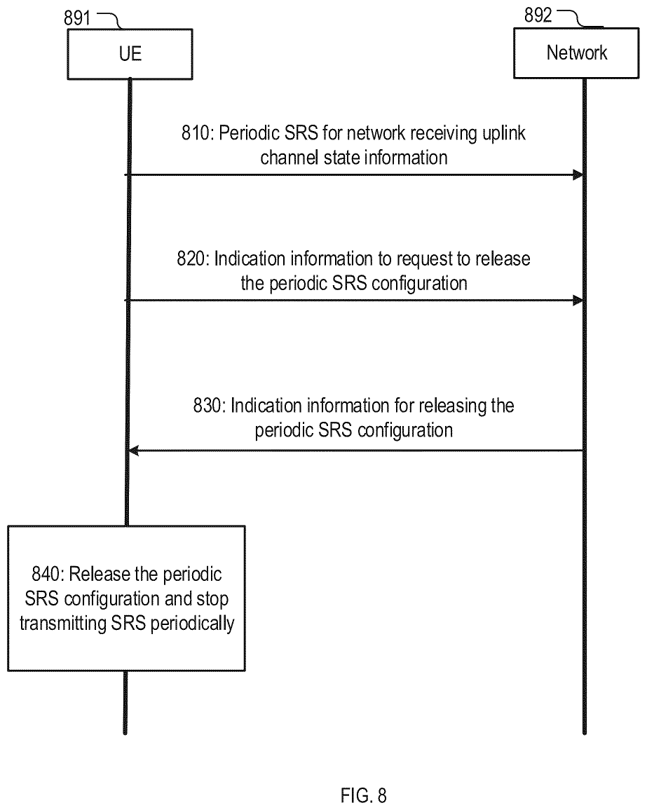

FIG. 8 shows a system flow of a UE (891) requesting a wireless network node (e.g., a network) (892) to release the periodic SRS configuration. In step 810: the UE transmits SRS periodically for the wireless network node receiving the uplink channel state information; step 820, when the available power of the UE is insufficient, UE may exit the sensing task and transmit an indication information to wireless network node to request releasing the periodic SRS configuration; step 830, the wireless network node transmits an indication information for releasing periodic SRS configuration for the UE; and/or step 840, the UE releases the periodic SRS configuration and stops transmitting SRS periodically.

For another non-limiting example, indication information transmitted by a UE for requesting to release periodic SRS configuration includes at least one of the following: Layer 1 (L1) signaling, or Layer 2 (L2) signaling, or Layer 3 (L3) signaling, or Radio Resource Control (RRC) messages, or information included in some RRC messages.

In some implementations, the L1 signaling may be one of uplink control information (UCI) having a fixed size of one bit, and the value of the bit may be 0 or 1. For example, when the value is 1, it means that the UE requests to release the periodic SRS configuration; and/or when the value is 0, it means that the UE does not request to release the periodic SRS configuration. Optionally in some implementations, the format of this L1 signaling may be similar to scheduling request (SR).

In some implementations, the L2 signaling may be one of Medium Access Control Control Element (MACCE), identified by a Medium Access Control (MAC) subheader with Logical Channel Index (LCID) and having a fixed size of zero bits. In some implementations, the MAC CE with the LCID indicates requesting to release the periodic SRS configuration. Optionally in some implementations, the format of this L2 signaling may be similar to the configured grant confirmation MAC CE.

For another non-limiting example, when a UE is not configured with periodic SRS resources and needs transmitting SRS periodically, the UE may transmit an indication information to a wireless network node to request configuring the periodic SRS configuration for the UE. After the UE has been configured with periodic SRS configuration by the wireless network node, the UE may transmit SRS periodically.

In some implementations, from the UE side, the UE flow of requesting configuring periodic SRS configuration may include a portion or all of the following: the UE transmits an indication information to the wireless network node to request configuring periodic SRS configuration; the UE receives an indication information for configuring the periodic SRS configuration from the wireless network node; and/or the UE configures the periodic SRS configuration and transmits SRS periodically.

The present disclosure describes methods, apparatus, and computer-readable medium for wireless communication. The present disclosure addressed the issues with requesting release of configuration of periodic sounding reference signal. The methods, devices, and computer-readable medium described in the present disclosure may facilitate the performance of wireless communication by requesting release of configuration of periodic sounding reference signal, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a wireless communication device to a wireless communication node, first information for requesting to release a periodic SRS configuration;
receiving, by the wireless communication device from the wireless communication node, second information for releasing the periodic SRS configuration; and
releasing, by the wireless communication device, the periodic SRS configuration.

2. The method according to claim 1, wherein:
the first information may be an uplink control information (UCI) having a fixed size of one bit, wherein a value of the UCI being one indicates requesting to release the periodic SRS configuration.

3. The method according to claim 1, wherein:
the first information may be a medium access control control element (MAC CE) comprising a MAC header with a logical channel index (LCID) and a fixed size of zero bit, wherein the MAC CE with the LCID indicates requesting to release the periodic SRS configuration.

4. (canceled)

5. A method for wireless communication, comprising:
receiving, by a wireless communication node from a wireless communication device, first information for requesting to release a periodic SRS configuration; and
transmitting, by the wireless communication node to the wireless communication device, second information for releasing the periodic SRS configuration.

6. The method according to claim 5, wherein:
the first information may be an uplink control information (UCI) having a fixed size of one bit, wherein a value of the UCI being one indicates requesting to release the periodic SRS configuration.

7. The method according to claim 5, wherein:
the first information may be a medium access control control element (MAC CE) comprising a MAC header with a logical channel index (LCID) and a fixed size of zero bit, wherein the MAC CE with the LCID indicates requesting to release the periodic SRS configuration.

8. (canceled)

9. (canceled)

10. (canceled)

11. An apparatus comprising:
a memory storing instructions; and
at least one processor in communication with the memory, wherein, when the at least one processor executes the instructions, the at least one processor is configured to cause the apparatus to perform:
transmitting, to a wireless communication node, first information for requesting to release a periodic SRS configuration;
receiving, from the wireless communication node, second information for releasing the periodic SRS configuration; and
releasing the periodic SRS configuration.

12. The apparatus according to claim 11, wherein:
the first information may be an uplink control information (UCI) having a fixed size of one bit, wherein a value of the UCI being one indicates requesting to release the periodic SRS configuration.

13. The apparatus according to claim 11, wherein:
the first information may be a medium access control control element (MAC CE) comprising a MAC header with a logical channel index (LCID) and a fixed size of zero bit, wherein the MAC CE with the LCID indicates requesting to release the periodic SRS configuration.

14. An apparatus comprising:
a memory storing instructions; and
at least one processor in communication with the memory, wherein, when the at least one processor executes the instructions, the at least one processor is configured to cause the apparatus to perform:
receiving, by a wireless communication node from a wireless communication device, first information for requesting to release a periodic SRS configuration; and
transmitting, by the wireless communication node to the wireless communication device, second information for releasing the periodic SRS configuration.

15. The apparatus according to claim 14, wherein:
the first information may be an uplink control information (UCI) having a fixed size of one bit, wherein a value of the UCI being one indicates requesting to release the periodic SRS configuration.

16. The apparatus according to claim 14, wherein:
the first information may be a medium access control control element (MAC CE) comprising a MAC header with a logical channel index (LCID) and a fixed size of zero bit, wherein the MAC CE with the LCID indicates requesting to release the periodic SRS configuration.
